(19) United States
(12) Patent Application Publication
(10) Pub. No.: US 2025/0318000 A1
(43) Pub. Date: Oct. 9, 2025

(54) COMMUNICATION APPARATUS, CONTROL METHOD FOR COMMUNICATION APPARATUS, AND STORAGE MEDIUM

(71) Applicant: CANON KABUSHIKI KAISHA, Tokyo (JP)

(72) Inventor: HIDEAKI TACHIBANA, Kanagawa (JP)

(21) Appl. No.: 19/242,589

(22) Filed: Jun. 18, 2025

Related U.S. Application Data
(63) Continuation of application No. PCT/JP2023/044217, filed on Dec. 11, 2023.

(30) Foreign Application Priority Data
Dec. 21, 2022 (JP) 2022-204894

(51) Int. Cl. H04W 76/14; H04W 12/06; H04W 84/12

(52) U.S. Cl. CPC H04W 76/14; H04W 12/06; H04W 84/12

(57) ABSTRACT

A communication apparatus capable of performing communication by Wi-Fi Direct (registered trademark) includes an acquisition unit configured to acquire information on a frequency used for Wi-Fi Direct communication, and a providing unit configured to provide a communication parameter to another communication apparatus by Wi-Fi Easy Connect in a case where the frequency is a predetermined frequency, the communication parameter including information indicating Wi-Fi Protected Access 3 (WPA3) and being necessary for performing the Wi-Fi Direct communication.

### CROSS-REFERENCE TO RELATED APPLICATIONS

This application is a Continuation of International Patent Application No. PCT/JP2023/044217, filed Dec. 11, 2023, which claims the benefit of Japanese Patent Application No. 2022-204894, filed Dec. 21, 2022, both of which are hereby incorporated by reference herein in their entirety.

### BACKGROUND OF THE INVENTION

### Field of the Invention

The present invention relates to setting of a communication parameter.

### Background Art

Apparatuses each having a wireless LAN (local area network) access point function to directly connect electronic apparatuses to each other have been widely used. To implement such a wireless LAN access point function, for example, a standard specification called Wi-Fi Direct (registered trademark, hereinafter referred to as WFD) established by Wi-Fi Alliance is disclosed in Wi-Fi Peer-to-Peer (P2P) Specification v1.9. WFD provides various kinds of parameters, such as communication parameters necessary for communication, from an access point to a client, and sets the parameters. The communication parameters are provided using Wi-Fi Protected Setup (hereinafter referred to as WPS).

Further, as a technique for sharing communication parameters for accessing a wireless network, a Wi-Fi Easy Connect (registered trademark, hereinafter referred to as WEC) standard is formulated. United States Patent Application Publication No. 2017/0295448 discusses that an apparatus called a configurator provides the communication parameters to an apparatus called an enrollee.

Further, in Wi-Fi Alliance, a new standard is being formulated, and for example, communication in a frequency band of 6 GHz is being studied.

### CITATION LIST

### Patent Literature

PTL 1: United States Patent Application Publication No. 2017/0295448

### SUMMARY OF THE INVENTION

A communication apparatus capable of performing communication by Wi-Fi Direct (registered trademark) includes an acquisition unit configured to acquire information on a frequency used for Wi-Fi Direct communication, and a providing unit configured to provide a communication parameter to another communication apparatus by Wi-Fi Easy Connect in a case where the frequency is a predetermined frequency, the communication parameter including information indicating Wi-Fi Protected Access 3 (WPA3) and being necessary for performing the Wi-Fi Direct communication.

Further features of the present invention will become apparent from the following description of exemplary embodiments with reference to the attached drawings.

### BRIEF DESCRIPTION OF THE DRAWINGS

FIG. 1 is a diagram illustrating a configuration of a communication apparatus.

FIG. 2 is a diagram illustrating a software functional configuration of the communication apparatus.

FIG. 3 is a diagram illustrating an example of a configuration of a communication system.

FIG. 4 is a diagram illustrating a sequence between communication apparatuses according to a first exemplary embodiment.

FIG. 5 is a diagram illustrating an operation flow of a camera according to the first exemplary embodiment.

FIG. 6 is a diagram illustrating an operation flow of a camera according to a second exemplary embodiment.

FIG. 7 is a diagram illustrating a flow of WEC processing.

### DESCRIPTION OF THE EMBODIMENTS

### First Exemplary Embodiment

A communication apparatus according to a first exemplary embodiment is described in detail below with reference to drawings. Hereinafter, an example using a wireless LAN system compliant with IEEE (Institute of Electrical and Electronics Engineers) 802.11 series is described. However, a communication form is not necessarily limited to wireless LAN compliant with IEEE802.11.

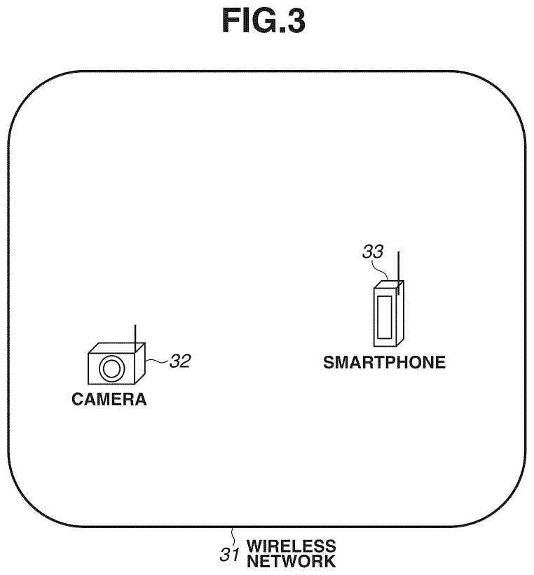

FIG. 3 illustrates a communication system according to the present exemplary embodiment. The communication system illustrated in FIG. 3 includes a camera 32 and a smartphone 33. A wireless network 31 is a wireless LAN network formed by the camera 32 or the smartphone 33. In other words, the wireless network 31 is a wireless LAN network provided by the camera 32 or the smartphone 33 serving as a group owner of Wi-Fi Direct. Hereinafter, an example where the wireless LAN network is Wi-Fi Direct is described, but this is not limiting. The wireless network 31 is formed in a 6 GHz band here, but may be formed in another frequency band. In communication in the 6 GHz band, an authentication method of Wi-Fi Protected Access 3 (WPA3) is necessary. Therefore, the wireless network 31 is formed in the 6 GHz band, and WPA3 is selected as the authentication method. Further, in a case where communication parameters including information indicating WPA3 are to be provided by Wi-Fi Direct or the like, it is considered to use a Wi-Fi Easy Connect (WEC) method. In the present exemplary embodiment, a description is provided on formation of the wireless network 31 by the camera 32 and the smartphone 33 using Wi-Fi Direct.

As apparatuses in the communication system according to the present exemplary embodiment, the camera and the smartphone are described; however, the apparatuses may be other communication apparatuses such as a printer, a mobile phone, a PC, a video camera, a smartwatch, and a PDA.

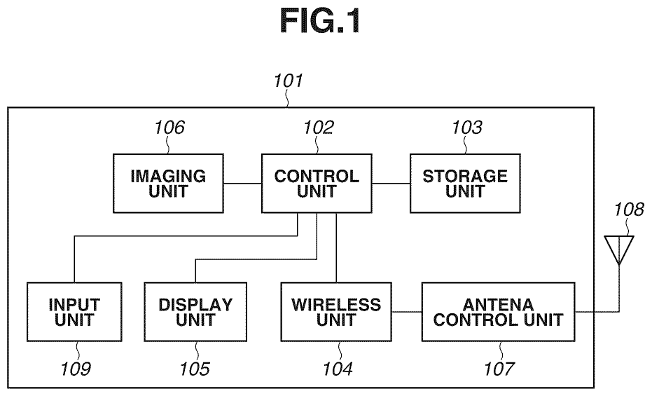

A hardware configuration of each of the apparatuses in the communication system illustrated in FIG. 3 according to the present exemplary embodiment is described with reference to FIG. 1. In FIG. 1, an entire apparatus is indicated by 101. A control unit, indicated by 102, controls the entire apparatus by executing control programs stored in a storage unit 103. The control unit 102 includes, for example, a CPU (central processing unit). A storage unit, indicated by 103, stores various kinds of information such as the control programs to be executed by the control unit 102, image data, and communication parameters. Various kinds of operation described below are performed when the control unit 102 executes the control programs stored in the storage unit 103. The storage unit 103 includes a storage medium such as a RAM, a HDD, a flash memory, and a detachable SD card. A wireless unit for performing wireless LAN communication compliant with IEEE802.11 series is indicated by 104. The wireless unit 104 includes a chip that performs wireless communication. The wireless unit 104 can also perform short-range wireless communication such as NFC and Bluetooth (registered trademark). A display unit, indicated by 105, performs various kinds of display, and the display unit 105 has a function of outputting visually recognizable information, such as an LCD or an LED, or a function of outputting sound, such as a speaker.

The display unit 105 includes a function of outputting at least one of visual information and sound information. In a case where the display unit 105 displays the visual information, the display unit 105 includes a VRAM (video RAM) that holds image data corresponding to the visual information to be displayed. The display unit 105 performs display control for causing the LCD or the LED to continuously display the image data stored in the VRAM. An imaging unit, indicated by 106, includes an imaging element, a lens, and the like and captures a photograph and a moving image. In the present exemplary embodiment, the imaging unit 106 performs reading of code information such as a bar code, a two-dimensional code, and a QR Code (registered trademark). An antenna control unit, indicated by 107, performs output control of an antenna 108. The antenna, indicated by 108, can perform communication in a 2.4 GHz band, a 5 GHz band, and a 6 GHz band to perform communication by the wireless LAN. An input unit, indicated by 109, allows a user to perform various kinds of input and the like to operate the communication apparatus 101, and includes a touch panel, a key board, a button, and the like. The input unit 109 stores a flag corresponding to the input in a memory such as the storage unit 103.

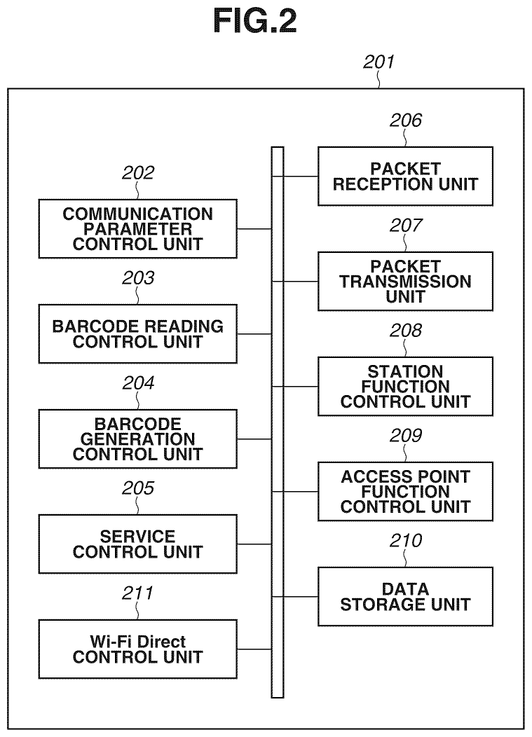

FIG. 2 is a block diagram illustrating an example of a configuration of software functional blocks performing a communication control function described below. In the present exemplary embodiment, the functional blocks in each of the apparatuses are stored as programs in the storage unit 103, and functions of the functional blocks are implemented by the control unit 102 executing the programs. The control unit 102 implements the functions by controlling the hardware and performing calculation and processing of information based on the control programs. A part or all of the functional blocks may be implemented by hardware. In this case, a part or all of the functional blocks are consisting of, for example, an ASIC (application specific integrated circuit).

In FIG. 2, the entire software functional blocks are indicated by 201. A communication parameter control unit is indicated by 202. The communication parameter control unit 202 performs communication parameter sharing processing for sharing the communication parameters between the apparatuses. In the communication parameter sharing processing, a providing apparatus provides the communication parameters for performing wireless communication to a reception apparatus. The communication parameters include wireless communication parameters necessary for performing the wireless LAN communication, such as an SSID (Service Set Identifier) as a network identifier, a cryptography, a cryptographic key, an authentication method, and authentication information. The communication parameters may also include a MAC address, a passphrase, an IP address for performing communication in an IP layer, information necessary for a high-order service, and the like. The communication parameter sharing processing performed by the communication parameter control unit 202 uses WPS (Wi-Fi Protected Setup) or WEC that safely transfers the communication parameters by using a public-key cryptography, defined by Wi-Fi Alliance. WEC is synonymous with Device Provisioning Protocol (DPP).

As a public-key sharing method in WEC, a QR Code may be used, or Public Key Exchange (hereinafter referred to as PKEX) may be used. The processing for exchanging the communication parameters between two or more communication apparatuses is all performed by the communication parameter control unit 202.

A barcode reading control unit is indicated by 203. The barcode reading control unit 203 analyzes an image captured by the imaging unit 106 and acquires a coded code information. The barcode reading control unit 203 performs analysis processing of the code information such as a bar code, a two-dimensional code, and a QR Code. A barcode generation control unit is indicated by 204. The barcode generation control unit 204 generates the code information such as a bar code, a two-dimensional code, and a QR Code and controls the display unit 105 to display the generated code information. A service control unit in an application layer is indicated by 205. The application layer used herein indicates a service providing layer in a high-order layer that is higher than or equal to a fifth layer in an OSI reference model. In other words, the service control unit 205 performs print processing, image streaming processing, file transfer processing, and the like by using the wireless communication by the wireless unit 104. For example, the service control unit 205 transmits an image generated by reading a document by a scanner through the wireless communication by the wireless unit 104, or prints an image acquired through the wireless communication. Further, the service control unit 205 transmits an image captured by a camera through the wireless communication, or transmits the image to a projector through the wireless communication. A packet reception unit is indicated by 206, and a packet transmission unit is indicated by 207. The packet reception unit 206 and the packet transmission unit 207 control reception and transmission of all packets including a communication protocol of a high-order layer. The packet reception unit 206 and the packet transmission unit 207 also control the wireless unit 104 to transmit and receive a packet compliant with the IEEE802.11 standards and a packet of the short-range wireless communication such as NFC or Bluetooth (registered trademark), to and from a counterpart apparatus.

A station function control unit, indicated by 208, provides a station (STA) function for operating as an STA in an infrastructure mode defined in the IEEE802.11 standards, and the STA function control unit 208 performs authentication/cryptographic processing, and the like when operating as the STA. An access point function control unit, indicated by 209, provides an access point (AP) function of operating as an AP in the infrastructure mode defined in the IEEE802.11 standards. The AP function control unit 209 forms a wireless network, and performs the authentication/cryptographic processing for the STA, management of the STA, and the like. A data storage unit, indicated by 210, controls writing and reading of software itself, the communication parameters, and information such as bar codes, to and from the storage unit 103.

A Wi-Fi Direct control unit, indicated by 211, performs various kinds of processing based on specifications of the above-described Wi-Fi Direct. In Wi-Fi Direct communication, a communication apparatus implementing a wireless LAN access point function is referred to as a P2P group owner (hereinafter, GO), and a communication apparatus implementing a wireless LAN station function is referred to as a P2P client (hereinafter, CL). The Wi-Fi Direct control unit 211 functions to operate as a GO or a CL. These roles are determined by a protocol of GO Negotiation and are defined in the Wi-Fi Direct specifications. For details, see Wi-Fi Peer-to-Peer (P2P) Specification v1.9. In Wi-Fi Direct, a network formed by the GO is referred to as a P2P group. In a case where the apparatus has a role of the GO, the access point function control unit 209 operates, whereas in a case where the apparatus has a role of the CL, the station function control unit 208 operates.

The above-described functional blocks are illustrative. A plurality of functional blocks may constitute one functional block, or any functional block may be further divided into blocks performing a plurality of functions.

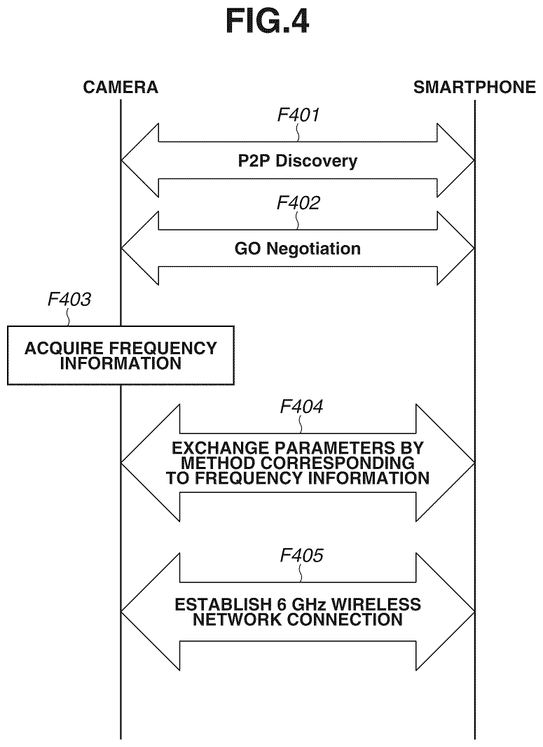

Operation of the communication system including the above-described configuration will be described. FIG. 4 illustrates a connection sequence during communication connection by Wi-Fi Direct between the communication apparatuses of the camera 32 and the smartphone 33.

An example in which the camera 32 is started up as the GO of Wi-Fi Direct is described.

In F401, the smartphone 33 and the camera 32 each perform apparatus searching processing (P2P Discovery processing) defined in the Wi-Fi Direct specifications in order to recognize each other.

In a case where the camera 32 and the smartphone 33 have found each other, the camera 32 and the smartphone 33 perform GO determination processing (GO Negotiation processing) defined in the Wi-Fi Direct specifications in F402. At this time, in F403, the camera 32 acquires information on a frequency from the smartphone 33. The frequency acquired at this time is a frequency usable by the smartphone 33, and is a frequency used to form a network described below. For example, in a case where Bit 6 is set in P2P Capability attribute included in GO Negotiation Request or Response, the camera 32 interprets that 6 GHz is used. In this example, the frequency to be used is determined based on the P2P Capability attribute; however, determination of the frequency is not limited thereto. For example, the frequency to be used may be determined based on Channel List or a channel number included in GO Negotiation Request or Response, or the frequency to be used may be determined based on information included in a probe request or a probe response in the P2P discovery processing. Further, the camera 32 may be configured to determine the frequency to be used by the camera 32 without acquiring the frequency to be used from the counterpart apparatus, or may acquire a plurality of usable frequencies from the counterpart apparatus and determine the frequency to be used from the acquired plurality of frequencies.

The frequency to be used may be previously determined by setting by user operation.

In F404, the camera 32 exchanges the communication parameters with the smartphone 33 by a method corresponding to the frequency acquired in F403. For example, in a case where it is determined that a network is to be formed at 6 GHz from the information acquired in F403, the camera 32 exchanges the communication parameters of WPA3 based on a WEC method in order to form a 6 GHz network by the authentication method of WPA3. In this example, 6 GHz is used, but also in a case of using 7 GHz, the communication parameters of WPA3 may be exchanged based on the WEC method. In a case where it is determined that the network is to be formed at a frequency other than 6 GHz from the frequency information acquired in F403, the camera 32 exchanges the communication parameters of WPA2 based on the WPS method in order to form a network by an authentication method of WPA2. Even in a case of using a frequency other than 6 GHZ, the communication parameters of WPA3 may be exchanged using WEC. Alternatively, in the case of using 6 GHz, the communication parameters of WPA3 may be exchanged by WPS. In F405, the camera 32 and the smartphone 33 establish wireless network connection by using the exchanged communication parameters.

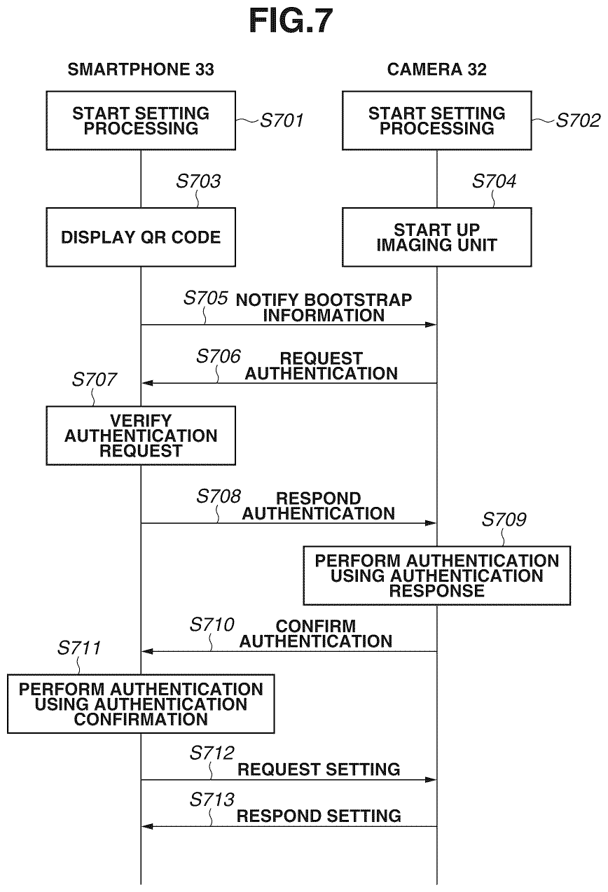

A sequence in which the camera 32 and the smartphone 33 exchange the communication parameters by the WEC method is described with reference to FIG. 7. The sequence is processing corresponding to F404 in FIG. 4. As an example, the public key sharing method of WEC is a QR Code, the smartphone 33 is a responder providing bootstrap information, and the camera 32 is an initiator receiving the bootstrap information. An example in which the communication parameters are provided from the camera 32 to the smartphone 33 is described, but this is not limiting.

In S701 and S702, the smartphone 33 and the camera 32 start communication parameter setting processing.

In S703, the smartphone 33 displays, as a QR Code, bootstrap information including a public key and waits for an authentication request. In a case where the smartphone 33 does not receive the authentication request within a predetermined time, the smartphone 33 may end waiting for the authentication request. In a case where the smartphone 33 does not include a display or the like for displaying the QR Code and the QR Code is printed on a label or the like stuck on a housing or an accessary, S703 is skipped. In S704, the camera 32 starts up the imaging unit to image the QR Code displayed by the smartphone 33 (or printed on a label or the like). In S705, by the imaging unit of the camera 32 imaging the QR Code, the camera 32 acquires information indicated by the QR Code. The method of outputting the bootstrap information is not limited to display of the QR Code. The bootstrap information may be notified using PKEX, or may be notified through short-range wireless communication such as NFC or Bluetooth. In this case, processing in S703 and S704 is skipped, and S705 is performed by wireless communication or short-range communication.

In S706, the camera 32 that has acquired the information indicated by the QR Code transmits an authentication request, and the smartphone 33 receives the authentication request. In S707, the smartphone 33 verifies contents of the received authentication request. In a case where the camera 32 having transmitted the authentication request is determined as an apparatus having imaged the QR Code, the smartphone 33 generates and transmits an authentication response indicating that the authentication is successful in S708. The smartphone 33 having transmitted the authentication response to the camera 32 waits for an authentication confirmation to be transmitted from the camera 32.

In S709, the camera 32 having received the authentication response verifies contents of the authentication response. In a case where the camera 32 determines that the authentication is successful, the camera 32 transmits an authentication confirmation indicating that the authentication is successful to the smartphone 33 in S710. Each of the smartphone 33 and the camera 32 causes the authentication request in S706 or the authentication response in S708 to include information indicating whether the smartphone 33 or the camera 32 operates as a configurator providing the communication parameters or as an enrollee receiving the communication parameters. In the authentication confirmation in S710, roles of the smartphone 33 and the camera 32 are determined. In this example, it is determined that the camera 32 operates as the configurator.

In S711, the smartphone 33 having received the authentication confirmation from the camera 32 in S710 verifies contents of the authentication confirmation. In a case where the smartphone 33 can correctly decode tag information by using a shared key generated by the smartphone 33, the smartphone 33 determines that the authentication is successful. When the smartphone 33 determines that the authentication is successful, the smartphone 33 transmits a setting request for requesting the communication parameters in S712, and waits for transmission of a setting response from the camera 32.

In S713, the camera 32 having received the setting request transmits the setting response including the communication parameters.

By the above-described processing, the communication parameters can be exchanged by the WEC method.

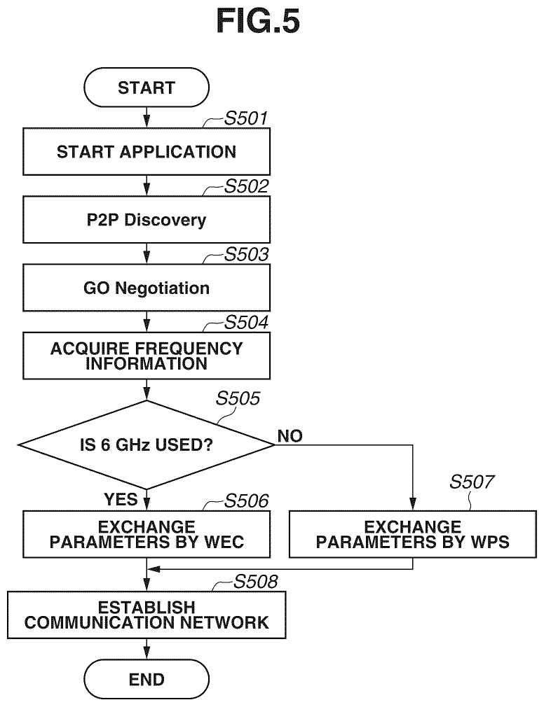

FIG. 5 is a flowchart illustrating an operation flow of the camera 32.

In S501, in response to an operation on the input unit 109 of the camera 32, the camera 32 starts up a communication parameter setting application.

In S502, after the application is started up, to detect the smartphone 33, the camera 32 performs the apparatus searching processing (P2P Discovery processing) defined in the Wi-Fi Direct specifications using the Wi-Fi Direct control unit 211.

In S503, after the camera 32 detects the counterpart apparatus, the camera 32 performs the GO determination processing (GO Negotiation processing) defined in the Wi-Fi Direct specifications using the Wi-Fi Direct control unit 211 to determine the roles of the camera 32 and the smartphone 33. In determining the roles, a role of an initiator or a responder in WEC processing described below may be determined.

In S504, the Wi-Fi Direct control unit 211 acquires information on a frequency usable by the smartphone 33, i.e., the information on the frequency used for network connection described below. For example, the Wi-Fi Direct control unit 211 determines whether Bit 6 indicating support for 6 GHz is set in the P2P Capability attribute included in GO Negotiation Request/Response. In a case where Bit 6 is set, the Wi-Fi Direct control unit 211 determines to use 6 GHz. The apparatus serving as the GO and the apparatus serving as the CL determine the frequency to be used considering the frequency usable by the counterpart apparatus.

In S505, the Wi-Fi Direct control unit 211 determines whether to use 6 GHz based on the frequency information acquired in S504. In other words, the Wi-Fi Direct control unit 211 determines whether to form a network at 6 GHz. In a case where the Wi-Fi Direct control unit 211 determines to use 6 GHZ (YES in S505), the processing proceeds to S506. In a case where the Wi-Fi Direct control unit 211 determines to use a frequency other than 6 GHz (NO in S505), the processing proceeds to S507. In this example, the Wi-Fi Direct control unit 211 determines whether to use 6 GHz, but alternatively, may determine whether to use 7 GHz.

In a case where it is determined in S505 that 6 GHz is used, the communication parameter control unit 202 exchanges the communication parameters based on the WEC method to form a 6 GHz network by the authentication method of WPA3 in S506. For example, in a case where the role of the camera 32 is determined to be the GO in S503, the camera 32 becomes the configurator that is a parameter providing apparatus in WEC. In S506, the communication parameter control unit 202 provides the communication parameters by the WEC method. In other words, the communication parameter control unit 202 provides the communication parameters by the processing illustrated in FIG. 7. In contrast, in a case where the role of the camera 32 is determined to be the CL in S503, the camera 32 becomes the enrollee that is a communication parameter reception apparatus in WEC. In S506, the communication parameter control unit 202 receives the communication parameters by the WEC method. Here, the example in which the apparatus serving as the GO becomes the configurator in WEC is described; however, it is not always necessary for the apparatus serving as the GO to become the configurator. The CL may become the configurator, or a communication apparatus as a third party may become the configurator.

The public-key sharing method in WEC may be a method using a QR Code, NFC, or Bluetooth, or may be PKEX (Public Key Exchange). In a case of using the QR Code, either the camera 32 or the smartphone 33 displays the QR Code on the display unit 105, and the other apparatus reads the QR Code using the imaging unit 106. As a result, the WEC processing is started. In a case of using PKEX, either the camera 32 or the smartphone 33 transmits PKEX Exchange Request using the wireless unit 104. As a result, the WEC processing is started.

The communication parameters provided by the WEC processing include a parameter indicating that the authentication method is WPA3. For example, SAE (Simultaneous Authentication of Equals) is specified in “Authentication and Key Management Type” included in DPP Configuration Object Parameters defined in WEC, which makes it possible to indicate that the authentication method is WPA3. The method of indicating WPA3 is not limited thereto. Further, the communication parameters may include an SAE password and the like. Here, in WPA3, a length of a key is not limited. The communication parameters including the parameter indicating that the authentication method is WPA3 are referred to as the communication parameters of WPA3.

In a case where it is determined in S505 that 6 GHz is to be used and the role of the camera 32 is the GO, the Wi-Fi Direct control unit 211 forms a 6 GHz network by the authentication method of WPA3. As the authentication method for participating in the formed network, WPA3 is used. The Wi-Fi Direct control unit 211 may form a network of WPA2/WPA3 Transition. The network of WPA2/WPA3 Transition is a network corresponding to both WPA2 and WPA3.

In a case where it is determined in S505 that a frequency other than 6 GH is to be used, the communication parameter control unit 202 exchanges the communication parameters based on specifications of WPS to form a network by the authentication method of WPA2. Here, “other than 6 GHz” is, for example, 2.4 GHz. The communication parameters provided by WPS processing include a parameter indicating that the authentication method is WPA2. More specifically, WPA2 Personal is specified in Authentication Type in a credential defined in WPS, which makes it possible to indicate that the authentication method is WPA2. In the present example, the communication parameters are exchanged by WPS in the case of “other than 6 GHz”, but this is not limiting, and the communication parameters of WPA2 may be exchanged by WEC. In this case, the communication parameters provided by the WEC processing can include a parameter indicating that the authentication method is WPA2. More specifically, PSK (Pre-Shared Key) is specified in “Authentication and Key Management Type” included in DPP Configuration Object Parameters, which makes it possible to indicate that the authentication method is WPA2.

The communication parameters may include PSK and the like. Here, in WPA2, a length of a key is limited. Hereinafter, the communication parameters including the parameter indicating that the authentication method is WPA2 are referred to as the communication parameters of WPA2. The length of the key included in the communication parameters of WPA2 is eight characters to 63 characters for a passphrase, and 64 characters for HEX. On the other hand, the length of the key included in the communication parameters of WPA2 is shorter than the length of the key included in the communication parameters of WPA3. The length of the key included in the communication parameters of WPA3 is one or more characters. The length of the key is different depending on the authentication method.

In a case where it is determined in S505 that a frequency other than 6 GHz is to be used and the role of the camera 32 is the GO, the Wi-Fi Direct control unit 211 forms a network by the authentication method of WPA2. As the authentication method for participating in the formed network, WPA2 is used.

In S508, the camera 32 and the smartphone 33 establish wireless network connection by using the communication parameters exchanged in S506 or S507.

As described above, in the case where the counterpart apparatus can perform communication at 6 GHz and the network is formed at 6 GHz, the communication parameters of WPA3 are exchanged by not WPS but WEC. In other words, appropriate communication parameters can be exchanged by an appropriate method. Herein, in the case where the network is formed at 6 GHz, the communication parameters of WPA3 are exchanged by WEC, but this case is not limiting. The communication parameters of WPA3 may be exchanged by WEC based on the network to be formed, settings by the user, and the like.

### Second Exemplary Embodiment

In the first exemplary embodiment, the example of the Wi-Fi Direct processing in which P2P Discovery and GO Negotiation are performed with the counterpart apparatus is described. In the present exemplary embodiment, a case where the Wi-Fi Direct processing is performed by Autonomous GO is described. In Autonomous GO, protocols of P2P Discovery and GO Negotiation in the Wi-Fi Direct specifications are not performed, and the communication apparatus automatically operates as the GO and forms the communication network in a series of processes.

In the present exemplary embodiment, a case where the camera 32 having an Autonomous GO function forms the wireless network 31 by using Wi-Fi Direct is described. A basic configuration is the same as that of the first exemplary embodiment. Thus, only differences are described.

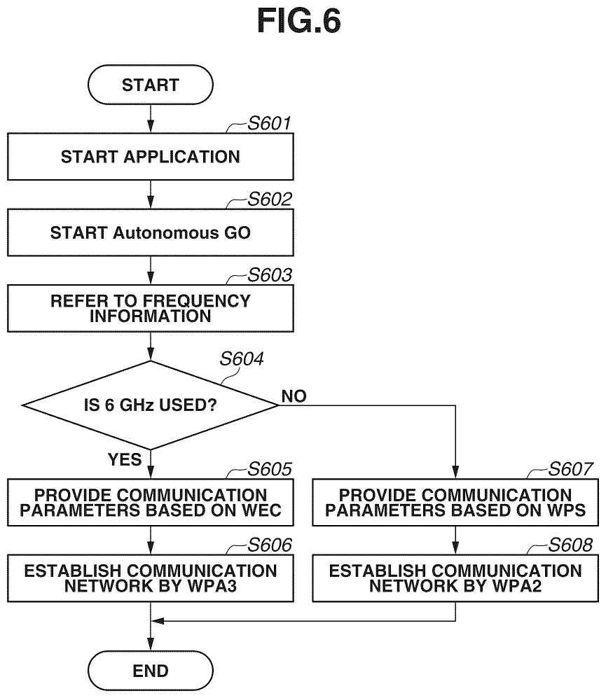

FIG. 6 is a flowchart illustrating an operation flow of the camera 32.

In S601, in response to an operation to the input unit 109 of the camera 32, the camera 32 starts up a communication parameter setting application.

In S602, after the application is started up, the Wi-Fi Direct control unit 211 starts operation as Autonomous GO of the Wi-Fi Direct specifications.

Next, in S603, the Wi-Fi Direct control unit 211 acquires information on a frequency used for network connection. Here, the frequency information may be based on communication network information set by the user on the input unit 109, or usable frequency information may be acquired from the smartphone 33 in the apparatus searching processing.

In S604, the Wi-Fi Direct control unit 211 determines whether to use 6 GHz based on the frequency information acquired in S603. In a case where the Wi-Fi Direct control unit 211 determines to use 6 GHz (YES in S604), the processing proceeds to S605. In a case where the Wi-Fi Direct control unit 211 determines to use a frequency other than 6 GHz (NO in S604), the processing proceeds to S607.

In a case where it is determined in S604 that 6 GHz is to be used, the communication parameter control unit 202 provides the communication parameters of WPA3 based on the WEC method to form a 6 GHz network by the authentication method of WPA3 in S605. Then, in S606, the Wi-Fi Direct control unit 211 forms a network using the authentication method of WPA3, and communicates with the smartphone 33 participating in the network.

In a case where it is determined in S604 that a frequency other than 6 GHz is to be used, the communication parameter control unit 202 provides the communication parameters of WPA2 based on the WPS method to form a network at a frequency other than 6 GHz by the authentication method of WPA2 in S607. In S608, the Wi-Fi Direct control unit 211 forms a network using the authentication method of WPA2, and communicates with the smartphone 33 participating in the network.

In the case where the network is formed at a frequency other than 6 GHz, it is not always necessary to form the network using the authentication method of WPA2. For example, a network using the authentication method of WPA3 may be formed, or a network of WPA2/WPA3 Transition may be formed.

With the above-described configuration, even in the case of performing operation as Autonomous GO, it is possible to provide the communication parameters by an appropriate method and to form an appropriate network.

### Other Exemplary Embodiments

In the above-described exemplary embodiments, the configuration in which the information for setting the communication parameters is exchanged between the apparatuses by using a QR Code or PKEX in the WEC processing is described. Alternatively, wireless communication such as NFC and Bluetooth may be used. Alternatively, wireless communication such as IEEE802.11ad or TransferJet (registered trademark) may be used. The QR Code to be read may be not only a QR Code displayed on the display unit, but also a QR Code in a form of a sticker or the like stuck on a housing of the communication apparatus. The QR Code to be read may be a QR Code stuck on an instruction manual or a package such as a cardboard box at the time of selling the communication apparatus. Further, in place of the QR Code, a bar code or a two-dimensional code may be used. Further, in place of information readable by a machine, such as a QR Code, information in a form readable by the user may be used.

In each of the exemplary embodiments, the case where the communication between the apparatuses is performed by wireless LAN communication compliant with IEEE802.11 is described; however, this is not limiting. The communication may be performed using a wireless communication medium of, for example, wireless USB, MBOA, Bluetooth, UWB, ZigBee, NFC, and the like. Here, MBOA is an abbreviation of Multi Band OFDM Alliance. Further, UWB includes wireless USB, wireless 1384, and WiNET.

The disclosure of the present exemplary embodiment includes the following configurations, a method, and a program.

### (Configuration 1)

A communication apparatus capable of performing communication by Wi-Fi Direct (registered trademark), the communication apparatus comprising:

an acquisition unit configured to acquire information on a frequency used for Wi-Fi Direct communication; and

a providing unit configured to provide a communication parameter to another communication apparatus by Wi-Fi Easy Connect in a case where the frequency is a predetermined frequency, the communication parameter including information indicating Wi-Fi Protected Access 3 (WPA3) and being necessary for performing the Wi-Fi Direct communication.

### (Configuration 2)

The communication apparatus according to Configuration 1, wherein, in a case where the frequency is not the predetermined frequency, the providing unit provides a communication parameter including information indicating Wi-Fi Protected Access 3 (WPA2) by Wi-Fi Protected Setup (WPS).

### (Configuration 3)

The communication apparatus according to Configuration 1 or 2, wherein the predetermined frequency is 6 GHz.

### (Configuration 4)

The communication apparatus according to any one of Configurations 1 to 3, wherein the acquisition unit acquires the information on the frequency from the other apparatus.

### (Configuration 5)

The communication apparatus according to any one of Configurations 1 to 4, wherein the acquisition unit acquires the information on the frequency from GO Negotiation Request or Response.

### (Configuration 6)

The communication apparatus according to any one of Configurations 1 to 5, wherein the acquisition unit acquires the information on the frequency from a P2P

Capability attribute included in GO Negotiation Request or Response.

### (Configuration 7)

The communication apparatus according to Configuration 6, wherein, in a case where Bit 6 is set in the P2P Capability attribute included in GO Negotiation Request or Response, the acquisition unit interprets that the frequency is 6 GHz.

### (Configuration 8)

The communication apparatus according to any one of Configurations 1 to 7, wherein the communication apparatus operates as a configurator in Wi-Fi Easy Connect.

### (Configuration 9)

The communication apparatus according to any one of Configurations 1 to 8, wherein the communication apparatus operates as a group owner in Wi-Fi Direct.

### (Configuration 10)

The communication apparatus according to any one of Configurations 1 to 9, further comprising a formation unit configured to form a network at the predetermined frequency.

### (Configuration 11)

The communication apparatus according to any one of Configurations 1 to 10, wherein the providing unit switches between using Wi-Fi Easy Connect and using WPS for providing the communication parameter.

### (Configuration 12)

The communication apparatus according to any one of Configurations 1 to 11, wherein the information indicating Wi-Fi Protected Access 3 (WPA3) is information on Authentication and Key Management Type included in DPP Configuration Object Parameters.

### (Configuration 13)

The communication apparatus according to any one of Configurations 1 to 12, wherein the communication parameter includes a SSID (Service Set Identifier), a cryptography, a cryptographic key, and an authentication method.

### (Method 1)

A control method performed by a communication apparatus capable of performing communication by Wi-Fi Direct, the control method comprising:
acquiring information on a frequency used for Wi-Fi Direct communication; and
providing a communication parameter to another communication apparatus by Wi-Fi Easy Connect in a case where the frequency is a predetermined frequency, the communication parameter including information indicating Wi-Fi Protected Access 3 (WPA3) and being necessary for performing the Wi-Fi Direct communication.

### (Program 1)

A program for causing a computer to operate as the communication apparatus according to any one of Configurations 1 to 13.

The present invention is not limited to the above exemplary embodiments, and various changes and modifications can be made without departing from the spirit and scope of the present invention. Accordingly, the following claims are appended to disclose the scope of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus capable of performing communication by Wi-Fi Direct (registered trademark), the communication apparatus comprising:
an acquisition unit configured to acquire information on a frequency used for Wi-Fi Direct communication; and
a providing unit configured to provide a communication parameter to another communication apparatus by Wi-Fi Easy Connect in a case where the frequency is a predetermined frequency, the communication parameter including information indicating Wi-Fi Protected Access 3 (WPA3) and being necessary for performing the Wi-Fi Direct communication.

2. The communication apparatus according to claim 1, wherein, in a case where the frequency is not the predetermined frequency, the providing unit provides a communication parameter including information indicating Wi-Fi Protected Access 2 (WPA2) by Wi-Fi Protected Setup (WPS).

3. The communication apparatus according to claim 1, wherein the predetermined frequency is 6 GHz.

4. The communication apparatus according to claim 1, wherein the acquisition unit acquires the information on the frequency from the other communication apparatus.

5. The communication apparatus according to claim 1, wherein the acquisition unit acquires the information on the frequency from GO Negotiation Request or Response.

6. The communication apparatus according to claim 1, wherein the acquisition unit acquires the information on the frequency from a P2P Capability attribute included in GO Negotiation Request or Response.

7. The communication apparatus according to claim 6, wherein, in a case where Bit 6 is set in the P2P Capability attribute included in GO Negotiation Request or Response, the acquisition unit interprets that the frequency is 6 GHz.

8. The communication apparatus according to claim 1, wherein the communication apparatus operates as a configurator in Wi-Fi Easy Connect.

9. The communication apparatus according to claim 1, wherein the communication apparatus operates as a group owner in Wi-Fi Direct.

10. The communication apparatus according to claim 1, further comprising a formation unit configured to form a network at the predetermined frequency.

11. The communication apparatus according to claim 1, wherein the providing unit switches between using Wi-Fi Easy Connect and using WPS for providing the communication parameter.

12. The communication apparatus according to claim 1, wherein the information indicating Wi-Fi Protected Access 3 (WPA3) is information on Authentication and Key Management Type included in DPP Configuration Object Parameters.

13. The communication apparatus according to claim 1, wherein the communication parameter includes a SSID (Service Set Identifier), a cryptography, a cryptographic key, and an authentication method.

14. A control method performed by a communication apparatus capable of performing communication by Wi-Fi Direct, the control method comprising:
acquiring information on a frequency used for Wi-Fi Direct communication; and
providing a communication parameter to another communication apparatus by Wi-Fi Easy Connect in a case where the frequency is a predetermined frequency, the communication parameter including information indicating Wi-Fi Protected Access 3 (WPA3) and being necessary for performing the Wi-Fi Direct communication.

15. A non-transitory computer-readable storage medium storing instructions that, when executed by a computer, cause the computer to perform a control method performed by a communication apparatus capable of performing communication by Wi-Fi Direct, the control method comprising:
acquiring information on a frequency used for Wi-Fi Direct communication; and
providing a communication parameter to another communication apparatus by Wi-Fi Easy Connect in a case where the frequency is a predetermined frequency, the communication parameter including information indicating Wi-Fi Protected Access 3 (WPA3) and being necessary for performing the Wi-Fi Direct communication.
